(19) United States
(12) Patent Application Publication
(10) Pub. No.: US 2006/0097483 A1
(43) Pub. Date: May 11, 2006

(54) Force absorbing towing hitch

(76) Inventor: Gary A. White, Grygla, MN (US)

Correspondence Address: KINNEY & LANGE, P.A., THE KINNEY & LANGE BUILDING, 312 SOUTH THIRD STREET, MINNEAPOLIS, MN, 55415-1002, US

(21) Appl. No.: 11/051,389

(22) Filed: Feb. 4, 2005

Related U.S. Application Data
(60) Provisional application No. 60/626,803, filed on Nov. 10, 2004.

(51) Int. Cl. B60D 1/06

(52) U.S. Cl. 280/511

(57) ABSTRACT

A towing hitch comprises a tubular housing connected to a drawbar configured for connection to a hitch receiver mounted to a towing vehicle. A wall of the tubular housing is configured with an opening that extends a portion of a length of the housing. A force absorbing member is positioned within the housing on a base of the housing. A ball mount rests on the force absorbing member. The force absorbing member cushions the ball mount from downward forces of a trailer tongue mounted to the hitch, such as when the towing vehicle and the towed vehicle encounter rough road surfaces.

### CROSS-REFERENCE TO RELATED APPLICATION(S)

This application claims the benefit of Provisional Application No. 60/626,803 filed Nov. 10, 2004 for “Air Shock Receiver Hitch.”

### BACKGROUND OF THE INVENTION

The present invention generally relates to a towing hitch system for connecting a towing vehicle, such as an automobile or truck, to a vehicle to be towed (e.g., a trailer). In particular, the present invention pertains to a force absorbing towing hitch. Simple trailer hitch devices of the prior art comprise a ball mount coupled to a towing vehicle. The ball mount carries a towing ball, to which is connected the towing tongue of the towed vehicle. In the course of towing, forces and vibrations created by irregularities in the road surface are transferred between the trailer and the towing vehicle, causing undue wear on the trailer and on the towing hitch and producing jolts which can be felt by occupants of the towing vehicle. The object of the present invention is to simply and inexpensively provide a modified towing hitch with force absorbing capabilities.

### BRIEF SUMMARY OF THE INVENTION

A towing hitch for coupling a towed vehicle to a receiver mount on a towing vehicle comprises a tubular housing connected to a drawbar that is adapted to be mounted to the receiver mount. The housing comprises a wall configured to define an opening along a portion of a length of the tubular housing. The housing includes a base connected to the wall at a first end portion of the tubular housing and a cover connected to the wall at a second end portion of the tubular housing. A force absorber is positioned in the tubular housing at the base of the tubular housing. A ball mount is supported on the force absorber and is configured for connection to a towing tongue of the towed vehicle.

### BRIEF DESCRIPTION OF THE DRAWINGS

FIG. 1 is a first perspective view of the force absorbing towing hitch of the present invention.

FIG. 2 is a partially exploded top perspective view of the hitch of FIG. 1.

FIG. 3 is a top perspective view of the hitch of FIG. 2.

FIG. 4 is a first exploded perspective view of the hitch of FIG. 1.

FIG. 4a is a further exploded view of the hitch of FIG. 4.

FIG. 5 is a perspective view a second embodiment of a ball mount carrier of the force absorbing towing hitch of the present invention.

FIG. 5a is a partially exploded view of the ball mount carrier of FIG. 5.

FIG. 6 is an exploded view of the ball mount carrier of FIG. 5.

While the above-identified drawing figures set forth preferred embodiments of the invention, other embodiments are also contemplated, as noted in the discussion. In all cases, this disclosure presents the present invention by way of representation and not limitation. It should be understood that numerous other modifications and embodiments can be devised by those skilled in the art which fall within the scope and spirit of the principles of this invention. It should be specifically noted that the figures have not been drawn to scale as it has been necessary to enlarge certain portions for clarity.

### DETAILED DESCRIPTION

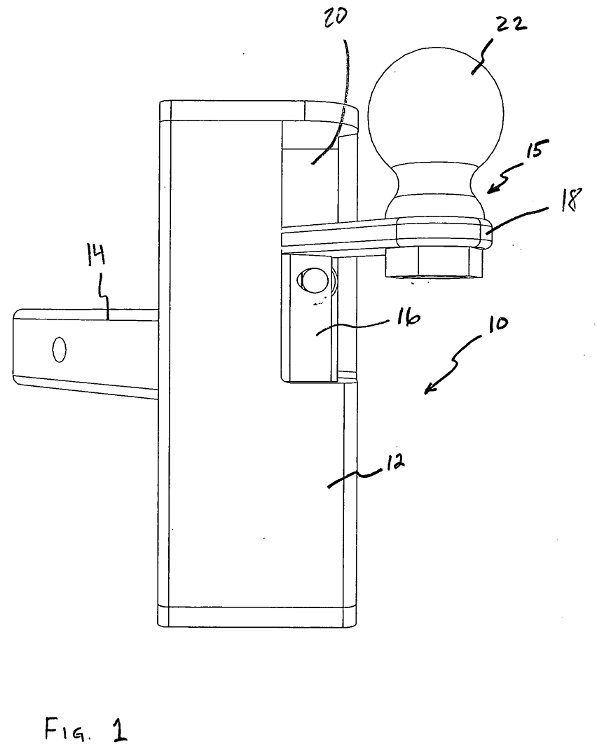

FIG. 1 is a first perspective view of the force absorbing towing hitch 10 of the present invention. As shown in FIG. 1, hitch 10 is generally comprised of a housing 12, which is supported on a drawbar 14 for connection to a vehicle mounted receiver (not shown). Situated withing housing 12 is a ball mount 15, which in one embodiment is comprised of a carrier 16 to which is mounted a ball platform 18. Ball platform 18 extends through an opening 20 formed in housing 12 opposite drawbar 14 and is configured to carry a towing ball 22. Opening 20 is sized to permit ball mount 15 to move up or down relative to a starting position shown in FIG. 1. Housing 12, drawbar 14, carrier 16 and ball platform 18 are all formed from a suitable durable metal, such as a structural grade steel.

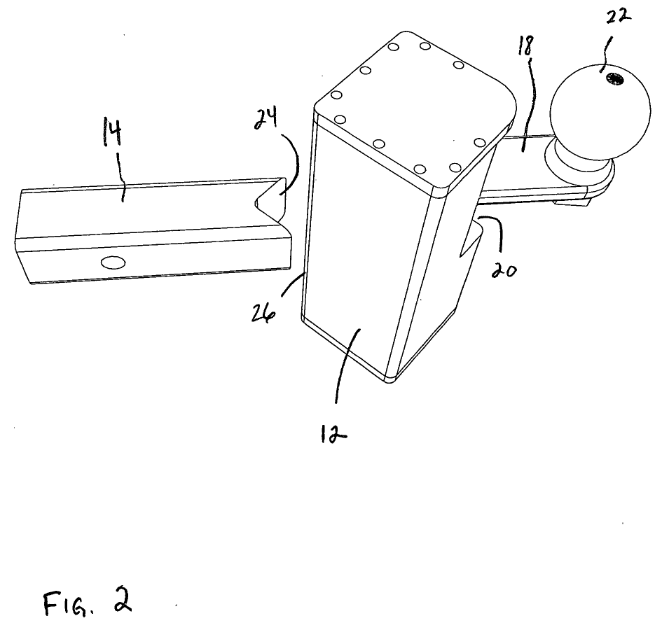

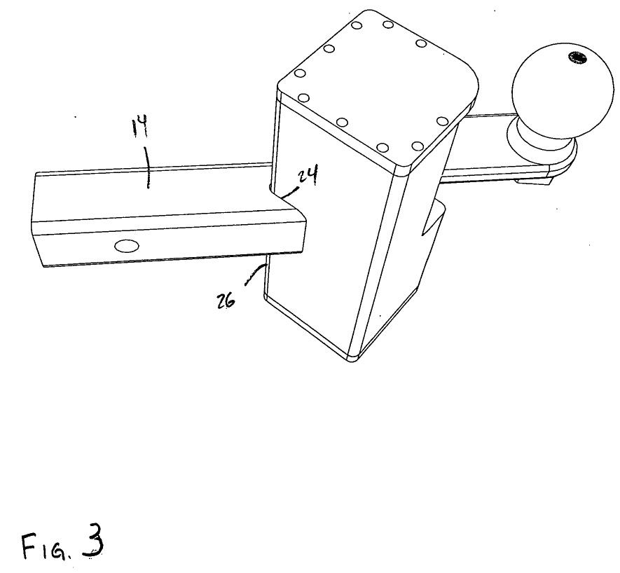

FIGS. 2 and 3 are top perspective views of hitch 10, which highlight the connection of drawbar 14 to housing 12. As shown in FIG. 2, drawbar 14 is machined at end 24 to define an angle that compliments the outer corner 26 of housing 12. As shown in FIG. 3, corner 26 of housing 12 is positioned within end 24 of drawbar 14 and secured thereto by welding.

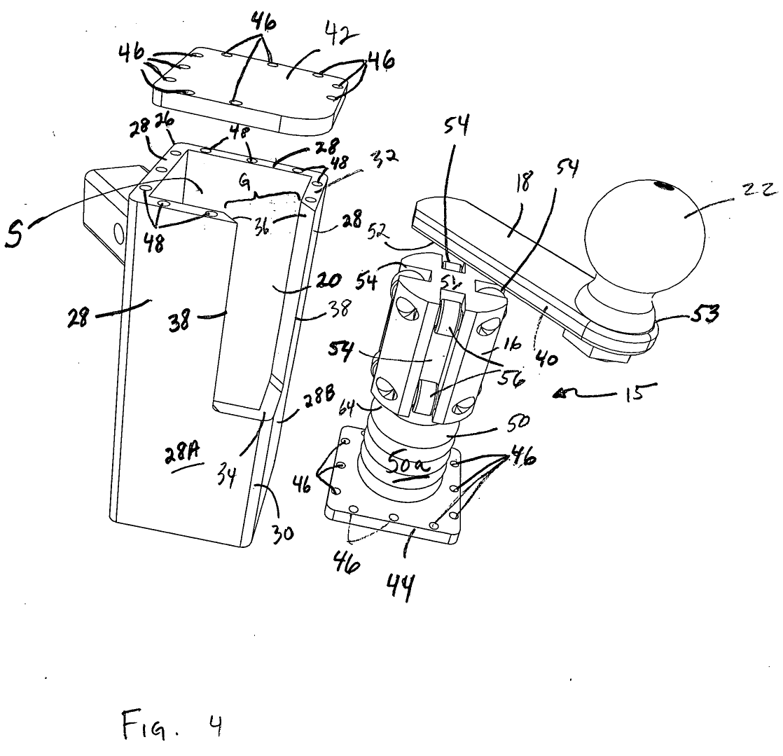

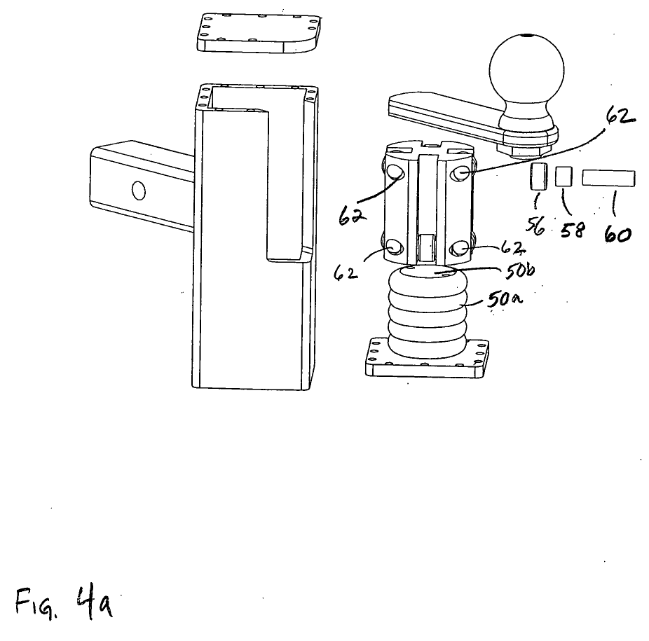

FIG. 4 is an exploded perspective view of hitch 10. As shown in FIG. 4, housing 12 has a tubular construction, which in the embodiment shown may comprise a square metal tube defined by walls 28. Walls 28 define an inner space S for containing ball mount 15. Opening 20 is defined by cutting and removing portions of walls 28A and 28B along outer corner 30 from upper end 32 of housing 12 approximately to a midpoint 34 of housing 12. Opening 20 defines a gap G between walls 28A and 28B that is sized to permit the insertion and movement of ball platform 18 within opening 20. As shown in FIG. 4, in one embodiment wall ends 36 of walls 28A, 28B are formed at an angle of about 45 degrees relative to edges 38 of opening 20 to complement the vertical side walls 40 of ball platform 18.

Housing 12 is enclosed by top and bottom metal plates 42 and 44, respectively, which are configured to match the outer dimensions of housing 12. In one embodiment, plates 42 and 44 are machined to include a plurality of holes 46 that align with complementary holes 48 in the ends of housing 12, so as to permit connection of plates 42 and 44 to housing 12 with suitable connectors, such as bolts. Alternatively, one or both of plates 42 and 44 may be secured to housing 12 by welding. While plates 42 and 44 are conveniently attachable to the ends of housing 12, it will be apparent to those of ordinary skill that plates 42 and 44 may be sized and mounted within the respective ends of housing 12 without departing from the intended purpose of the plates. Furthermore, one or more holes may be formed through bottom plate 44 or a lower portion of housing 12 to allow for draining of any fluid that may enter housing 12 through opening 20.

Positioned withing the inner space S of housing 12 are a force absorbing member 50, carrier 16 and a portion of ball platform 18. Ball platform 18 is an elongate narrow plate of steel having a lower end surface portion 52 secured to an upper end surface 51 of carrier 16 by welding. Ball platform 18 has a length suitable to extend from housing 12 a sufficient distance to connect a trailer tongue to ball 22 mounted to outer end portion 53 of ball platform 18.

In one embodiment, carrier 16 is formed from a generally cylindrical-shaped piece of hardened steel that is machined to define four equally radially spaced grooves 54 along the length of carrier 16. In one embodiment, each groove 54 is provided to locate a pair of guides 56 near opposite ends of carrier 16. As shown in FIG. 4a, each guide 56 may be in the form of a roller that is positioned over a bronze cylindrical insert 58 and mounted on a shaft 60 that is press fit into a pair of holes 62 formed in carrier 16 transverse to groove 54. As shown in FIGS. 4 and 4a, adjacent to each groove 54, a portion of the outer surface of carrier 16 is skived to permit guides 56 to define the point at which carrier 16 has its greatest outer diameter. As such, the outer diameter of carrier 16 is less than an inner diameter of housing 12 as defined by opposing parallel wall portions. The outer diameter of carrier 16 as defined by guides 56, however, generally is equal to the inner diameter of housing 12. In one embodiment, guides 56 are hardened steel rollers that engage an inner wall surface of housing 12 to center carrier 16 within housing 12 and permit carrier 16 to move up and down smoothly withing housing 12.

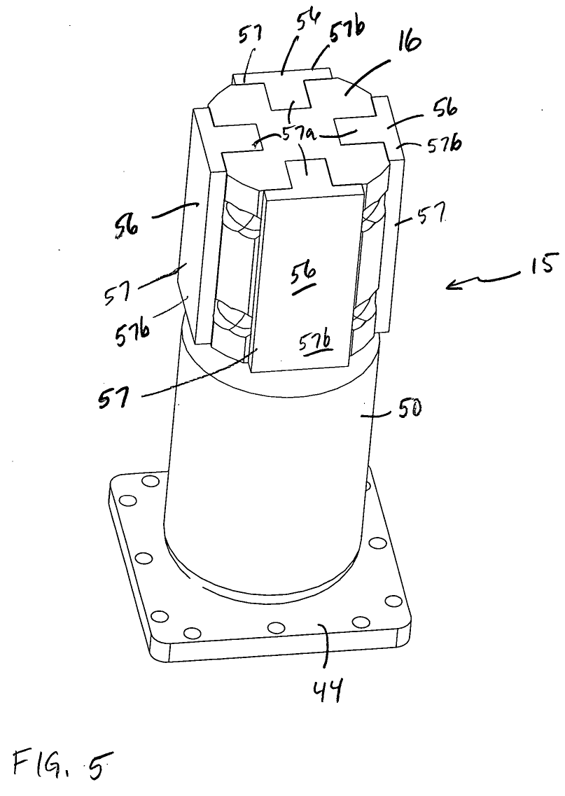

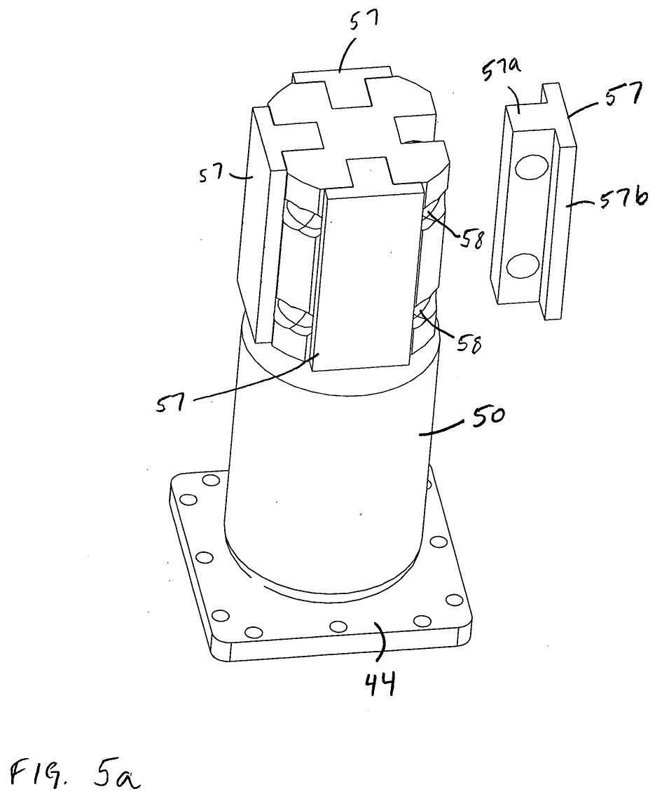

As shown in FIGS. 5 and 5a, in an alternate embodiment, guides 56 maybe in the form of anon-rotating skid 57. Skid 57 is configured with a groove-mating portion 57a, which is sized to fit within groove 54 of carrier 16, and a skid surface portion 57b that is generally normal to the groove-mating portion 57a. The groove-mating portion 57a is provided with a pair of spaced holes that align with holes 58 of carrier 16 to permit skid 57 to be connected to carrier 16 with pin connectors (not shown). In one embodiment, skid 57 is formed from metal, such as steel. As shown generally in FIGS. 4 and 5, the number of guides 56 employed in each groove is not critical to the operation of carrier 16, and a single guide 56 can be positioned in each groove 54 so as to support carrier 16 relative to the inner wall surface of housing 12.

Guides 56 serve as low cost wear members of carrier 16 that can be replaced as needed to inexpensively maintain hitch 10. However, an alternative embodiment of carrier 16 can be dimensioned to have an outer diameter such that the skived outer surface of carrier 16 engages the inner walls of housing 12 to permit carrier 16 to slide relative to housing 12. In such an embodiment, guides 56 are not included on carrier 16 and grooves 54 can be eliminated.

Referring again to FIGS. 4 and 4a, a lower end surface 64 of carrier 16 rests on force absorbing member 50. Force absorbing member 50 is dimensioned to support carrier 16 and cushion ball mount 15 from forces experienced from a trailer tongue mounted to ball 22, such as when towing a trailer over rough road surfaces. In one preferred embodiment, force absorbing member 50 comprises a fluid-filled polymeric bladder made and sold by Firestone Industrial Products Company under the trademark AIRIDE® Springs. As such, force absorbing member 50 generally comprises an air-filled natural rubber bladder 50a and end plates 50b, which are constructed of metal (FIG. 4a). A lower end plate 50b (not shown) of force absorbing member 50 is secured to an interior-facing surface of bottom plate 44, while upper end plate 50b is secured to carrier 16.

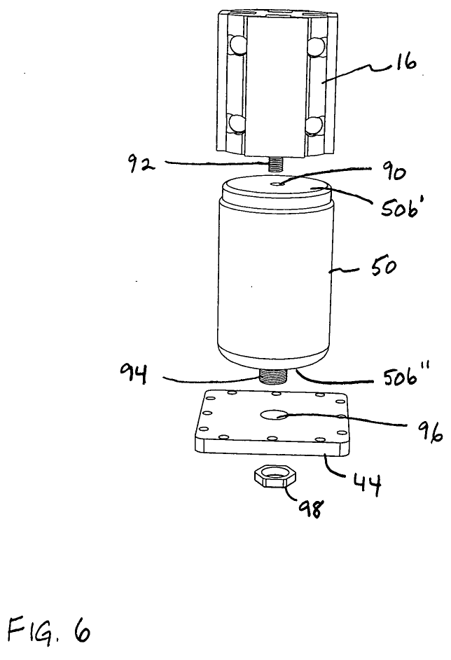

As shown in FIG. 6, in one embodiment, upper end plate 50b′ is formed with a recessed threaded bore 90 to which is connected a threaded stud 92. Stud 92 is in turn connected to a threaded bore in the lower surface of carrier 16 (not shown). Lower end plate 50b″ is configured with a threaded stud 94 and bottom plate 44 is provided with a hole 96 to permit connection of force absorbing member 50 to plate 44, such as with nut 98. The linking of carrier 16, force absorbing member 50 and bottom plate 44 together provides stability to hitch 10, and prevents rapid upward movement of the trailer tongue when depressions or bumps in the road are encountered. Other suitable ways of connecting carrier 16, force absorbing member 50 and bottom plate 44 with be apparent to those of ordinary skill in the art. In addition, force absorbing member 50 may be comprised of other force absorbing structures, such as a metal spring, a hydraulic or pneumatic shock absorber, etc.

The hitch of the present invention provides a simple, low cost alternative to static towing hitch assemblies with the added benefit of providing a smoother ride to a towed vehicle due to the force absorbing capability at the trailer tongue/towing hitch interface. The instant invention also minimizes the risk of structural damage to the towed vehicle and the towing hitch assembly mounted to the towing vehicle as a result of sudden and intense forces occasioned by chance encounters with road imperfections during the towing process.

Although the present invention has been described with reference to preferred embodiments, workers skilled in the art will recognize that changes may be made in form and detail without departing from the spirit and scope of the invention.

1. A towing hitch for coupling a towed vehicle to a towing vehicle having a receiver mount, the towing hitch comprising:
a drawbar adapted to be mounted to the receiver mount;
a tubular housing connected to the drawbar, the housing comprising:
a wall configured to define an opening along a portion of a length of the tubular housing;
a base connected to the wall at a first end portion of the tubular housing;
a cover connected to the wall at a second end portion of the tubular housing;
a force absorber positioned in the tubular housing at the base of the tubular housing; and
a ball mount supported on the force absorber and configured for connection to a towing tongue of the towed vehicle, the ball mount comprising:
a carrier positioned within the tubular housing and contacting the force absorber, the carrier being configured to engage an inner wall surface of the tubular housing:
a ball platform having a first end connected to the carrier, the ball platform extending through the opening in the tubular housing, the ball platform further having a second end configured to receive a towing ball: and
wherein the carrier comprises a metal body having an outer surface which defines an outer diameter of the carrier that is less than an inner diameter of the tubular housing, the carrier comprising a plurality of guides radially spaced about the carrier and connected to the carrier, each of the plurality of guides extending beyond the outer surface of the carrier to engage an inner wall of the tubular housing.

2. The towing hitch of claim 1 wherein the wall of the tubular housing is configured to define an opening along an outer corner of the tubular housing.

3. (canceled)

4. The towing hitch of claim 1 wherein the carrier comprises a metal body having an outer surface and an outer diameter such that a portion of the outer surface slidably engages an inner wall surface of the tubular housing.

5. (canceled)

6. The towing hitch of claim 1 wherein the carrier is configured with a plurality of radially spaced grooves that extend along a length of the carrier, the plurality of grooves located on the carrier to correspond to inner wall portions of the tubular housing, wherein each groove is configured to receive at least one of the plurality of guides.

7. The towing hitch of claim 6 wherein the carrier is configured with a plurality of bores, each bore being transverse to and in communication with each groove and wherein each guide comprises a roller, each roller carried on a shaft positioned within each bore.

8. The towing hitch of claim 1 wherein each groove of the carrier is configured to receive a pair of guides from the plurality of guides, the pair of guides being spaced relative to one another.

9. The towing hitch of claim 6 wherein the carrier is configured with first and second spaced bores transverse to and in communication with each groove and wherein each guide comprises a roller, each roller carried on a shaft positioned within each bore, wherein a portion of each roller is located within each respective groove and a portion of each roller extends from each respective groove so as to contact the inner wall of the tubular housing.

10. A towing hitch for coupling a towed vehicle to a towing vehicle having a receiver mount, the towing hitch comprising:
a drawbar adapted to be mounted to the receiver mount;
a housing connected to the drawbar, the housing having a tubular wall configured to define an opening along a portion of a length of the housing;
a force absorber positioned in the tubular housing;
a carrier positioned within the housing and having a first outer surface contacting the force absorber, the carrier further having a second outer surface configured to contact an inner wall surface of the housing, wherein the carrier comprises a metal body having an outer surface which defines an outer diameter of the carrier that is less than an inner diameter of the housing, the carrier further comprising a plurality of guides radially spaced about the carrier and connected to the carrier, each of the plurality of guides extending beyond the outer surface of the carrier to engage an inner wall of the tubular housing; and
a ball platform having a first end connected to the carrier, the ball platform extending through the opening in the housing, the ball platform further having a second end configured to receive a towing ball.

11. The towing hitch of claim 10 wherein the tubular wall of the housing is configured to define an opening along an outer corner of the housing.

12. The towing hitch of claim 10 wherein the carrier comprises a metal body having an outer surface and an outer diameter such that a portion of the outer surface slidably engages an inner wall surface of the housing.

13. (canceled)

14. The towing hitch of claim 10 wherein the carrier is configured with a plurality of radially spaced grooves that extend along a length of the carrier, the plurality of grooves located on the carrier to correspond to inner wall portions of the housing, wherein each groove is configured to receive at least one of the plurality of guides.

15. The towing hitch of claim 14 wherein the carrier is configured with a plurality of bores, each bore being transverse to and in communication with each groove and wherein each guide comprises a roller, each roller carried on a shaft positioned within each bore.

16. The towing hitch of claim 14 wherein each groove of the carrier is configured to receive a pair of guides from the plurality of guides, the pair of guides being spaced relative to one another.

17. The towing hitch of claim 14 wherein the carrier is configured with first and second spaced bores transverse to and in communication with each groove and wherein each guide comprises a roller, each roller carried on a shaft positioned within each bore, wherein a portion of each roller is located within each respective groove and a portion of each roller extends from each respective groove so as to contact the inner wall of the housing.

18. (canceled)
